(19) United States
(12) Patent Application Publication
(10) Pub. No.: US 2015/0046021 A1
(43) Pub. Date: Feb. 12, 2015

(54) SYSTEM AND METHOD FOR DIAGNOSING VEHICLE USING LEARNING VALUE

(71) Applicant: Hyundai Motor Company, Seoul (KR)

(72) Inventors: Hyoungsik KIM, Hwaseong-si (KR); Sang Woo PARK, Seoul (KR)

(73) Assignee: HYUNDAI MOTOR COMPANY, Seoul (KR)

(21) Appl. No.: 14/144,205

(22) Filed: Dec. 30, 2013

(30) Foreign Application Priority Data
Aug. 9, 2013 (KR) 10-2013-0094752

(51) Int. Cl. G07C 5/00

(52) U.S. Cl. CPC G07C 5/008
USPC 701/31.4; 701/33.4

(57) ABSTRACT

A method and system for diagnosing a vehicle using a learning value includes performing user authentication in response to an authentication request of a telematics terminal. The learning value is received from the telematics terminal and stored in a database. A set reference range is compared with the learning value stored in the database. It is determined whether the control system operates normally according to the comparison result, and a vehicle diagnosis result is stored in the database.

### CROSS-REFERENCE TO RELATED APPLICATION

This application claims the benefit of priority to Korean Patent Application No. 10-2013-0094752 filed in the Korean Intellectual Property Office on Aug. 9, 2013, the entire contents of which are incorporated herein by reference.

### TECHNICAL FIELD

The present disclosure relates to a system and a method for diagnosing a vehicle using a learning value, and more particularly, to a system and a method for diagnosing a vehicle using a learning value that determines whether a control system mounted on the vehicle operates normally by using the learning value.

### BACKGROUND

In general, a control system mounted on a vehicle controls learning in order to provide more precise control. A learning value, which is a value for correcting a deviation of respective hardware mounted on a vehicle, reduces a mass-production distribution of the hardware for each control system to precisely control.

For example, properties of fuel injection components and recognition of an air amount may change due to a production deviation and a deviation caused by a durability progress. An electronic control unit (ECU) used in a gasoline engine calculates a main fuel injection amount according to an engine RPM, an air amount, and a load state. In addition, a fuel correction amount is obtained by employing conditions such as a cooling water temperature, a fuel temperature, a cylinder deviation, acceleration and deceleration conditions, and the like, and a final fuel amount is achieved by applying the fuel correction amount to the main fuel injection amount. That is, the fuel correction amount for each cylinder is achieved by detecting an RPM deviation of respective cylinders.

Telematics, which is a term in which telecommunication and information science are combined, is defined as a vehicle information providing service through a combination of an IT industry in which wireless communication, a vehicle, a terminal, contents, and the like are mutually organically associated with each other, and a motor industry.

Telematics technology may collect vehicle information and provide various multimedia services such as traffic information, emergency rescue information, and Internet to a user by employing wireless communication technology and global positioning system (GPS) technology.

A vehicle diagnosing system, which is currently used, is a manual system that induces a user's response when a problem occurs in the vehicle. If an error occurred in a specific component cannot be detected in advance, other components linked with the specific component may also be damaged, and thus, vehicle repairing cost increases and a driver may be disaffected.

Accordingly, a method for determining whether the control system mounted on the vehicle is erroneous in advance by monitoring the learning value is necessary.

The above information disclosed in this Background section is only for enhancement of understanding of the background of the disclosure, and therefore, it may contain information that does not form the prior art that is already known in this country to a person of ordinary skill in the art.

### SUMMARY

The present disclosure provides a system and a method for diagnosing a vehicle using a learning value that determines whether a control system mounted on the vehicle operates normally by using the learning value.

According to an exemplary embodiment of the present disclosure, a method for diagnosing a vehicle using a learning value includes performing user authentication in response to an authentication request of a telematics terminal. The learning value is received from the telematics terminal, and stored in a database. A set reference range is compared with the learning value stored in the database. It is determined whether the control system operates normally according to a comparison result, and a vehicle diagnosis result is stored in the database.

In determining whether the control system operates normally, it may be determined that the control system operates normally when the learning value is within the set reference range, and that the control system operates abnormally when the learning value is out of the set reference range.

In receiving the learning value, the learning value may be received from the telematics terminal for each set driving distance.

The method may further include receiving a signal for requesting the vehicle diagnosis result from the telematics terminal and transmitting the vehicle diagnosis result to the telematics terminal.

The method may further include transmitting the vehicle diagnosis result to a used car market server.

The method may further include transmitting the vehicle diagnosis result to the telematics terminal or a portable terminal when the learning value is out of the set reference range, and transmitting the vehicle diagnosis result to a repairing center server.

The learning value may be a fuel correction amount for each cylinder.

According to another exemplary embodiment of the present disclosure, a system for diagnosing a vehicle using a learning value includes a telematics terminal collecting the learning value from the control system and transmitting the collected learning value to the outside. A telematics server receives the learning value from the telematics terminal, compares a set reference range with the learning value to determine whether the control system using the learning value operates normally according to a comparison result, and transmits a vehicle diagnosis result to the outside.

The telematics terminal may transmit the learning value to the telematics server for each set driving distance.

The system may further include at least one of a used car market server, a portable terminal, and a repairing center server that receive the vehicle diagnosis result.

The telematics terminal may include an information collector collecting the learning value from the control system. A terminal communicator transmits the collected learning value to the telematics server through a wireless communication network and receives the vehicle diagnosis result from the telematics server. A display displays the vehicle diagnosis result. A terminal controller transmits the collected learning value and controls the learning value collector, the terminal communicator, and the display to display the vehicle diagnosis result.

The telematics server may include a server communicator receiving the learning value from the telematics terminal and transmitting the vehicle diagnosis result to the telematics terminal. A database stores the learning value and the vehicle diagnosis result. A learning value analyzer compares a set reference range with the learning value stored in the database to determine whether the control system operates normally based on a comparison result. A server controller controls the server communicator, the database, and the learning value analyzer to transmit the vehicle diagnosis result to the telematics terminal.

### BRIEF DESCRIPTION OF THE DRAWINGS

FIG. 1 is a network configuration diagram schematically illustrating a configuration of a system for diagnosing a vehicle using a learning value according to an exemplary embodiment of the present disclosure.

FIG. 2 is a block diagram schematically illustrating a vehicle according to an exemplary embodiment of the present disclosure.

FIG. 3 is a block diagram schematically illustrating a telematics server according to an exemplary embodiment of the present disclosure.

FIG. 4 is a flowchart illustrating a method for diagnosing a vehicle using a learning value according to another exemplary embodiment of the present disclosure.

FIG. 5 is a graph measuring a fuel correction amount for each cylinder according to an exemplary embodiment of the present disclosure.

### DETAILED DESCRIPTION OF THE EMBODIMENTS

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

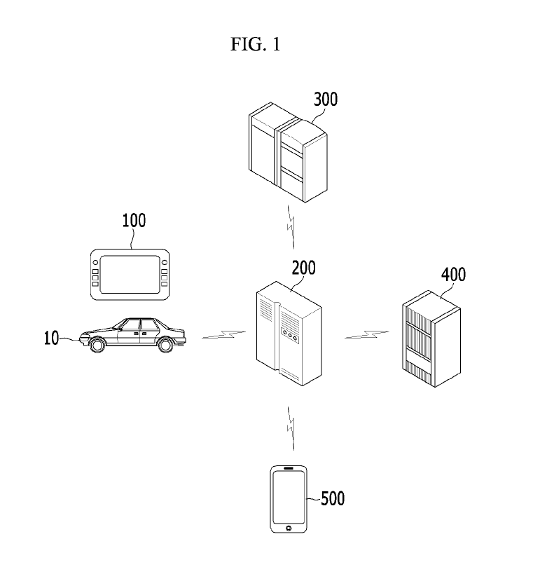

FIG. 1 is a network configuration diagram schematically illustrating a configuration of a system for diagnosing a vehicle using a learning value according to an exemplary embodiment of the present disclosure.

Referring to FIG. 1, the system for diagnosing a vehicle using a learning value according to an exemplary embodiment of the present disclosure includes a telematics terminal 100 and a telematics server 200 that are provided in a vehicle 10, and may further include a repairing center server 300, a used car market server 400, and a portable terminal 500.

The telematics terminal 100 collects vehicle information to transmit the collected vehicle information to the telematics server 200 through a wireless communication network.

The vehicle information may include a learning value, driving distance information, and information for user authentication.

The telematics server 200 stores information received from the telematics terminal 100 and determines whether a control system mounted on a vehicle operates normally based on the stored information.

The telematics server 200 is linked with the repairing center server 300, the used car market server 400, and the portable terminal 500 to transmit the learning value and a vehicle diagnosis result through a wireless/wired communication network.

The repairing center server 300 receives the learning value and the vehicle diagnosis result, and may use the learning value and the vehicle diagnosis result while repairing the vehicle.

The used car market server 400 receives the learning value and the vehicle diagnosis result. A used car seller or buyer may use accumulated learning values and vehicle diagnosis results when dealing with the used car.

The portable terminal 500 may be a smart phone or a smart pad.

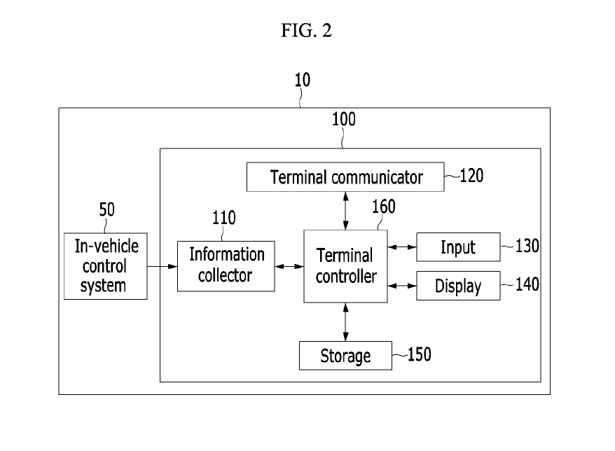

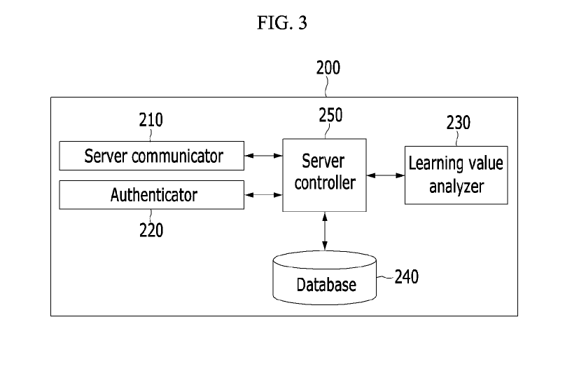

Referring to FIGS. 2 and 3, the telematics terminal 100 and the telematics server 200 according to an exemplary embodiment of the present disclosure will be described in more detail.

FIG. 2 is a block diagram schematically illustrating a vehicle according to an exemplary embodiment of the present disclosure.

Referring to FIG. 2, a vehicle 10 according to an exemplary embodiment of the present disclosure includes an in-vehicle control system 50 and a telematics terminal 100.

The in-vehicle control system 50 may include an electronic control unit (ECU) and a transmission control unit (TCU). The in-vehicle control system 50 collects vehicle information by using various sensors and an in-vehicle communication control system and as the in-vehicle communication control system, high-speed controller area network (CAN) communication may be used.

The telematics terminal 100 includes an information collector 110, a terminal communicator 120, an input 130, a display 140, and a terminal controller 160. Further, the telematics terminal 100 may further include a storage 150 storing the information collected by the information collector 110.

The information collector 110 collects the vehicle information from the in-vehicle control system 50. The vehicle information may include a learning value and driving distance information.

The collected information may be transferred to the storage 150, stored, and classified in the storage 150.

The information collected by the information collector 110 is transferred to the terminal controller 160. Further, required information is extracted from the information stored in the storage 150 to be transferred to the terminal controller 160.

The terminal communicator 120 transmits the collected information to the telematics server 200 through the wireless communication network. The terminal communicator 120 may transmit the learning value for each set driving distance under a control of the terminal controller 160. The set driving distance may be a value determined by those skilled in the art by considering a hardware deviation with a durability progress.

The terminal communicator 120 may transmit information for a user authentication to the telematics server 200. When a user requests the vehicle diagnosis result through the input 130, the terminal communicator 120 transmits a signal associated with the vehicle diagnosis result to the telematics server 200.

The display 140 may display the learning value and the vehicle diagnosis result under the control of the terminal controller 160.

The terminal controller 160 may be implemented by one or more microprocessors that operate by a set program, and the set program may include a series of commands for performing respective steps included in a vehicle diagnosing method according to an exemplary embodiment of the present disclosure to be described below. The terminal controller 160 controls an overall operation of the telematics terminal 100.

FIG. 3 is a block diagram schematically illustrating a telematics server according to an exemplary embodiment of the present disclosure.

Referring to FIG. 3, the telematics server 200 according to an exemplary embodiment of the present disclosure includes a server communicator 210, an authenticator 220, a learning value analyzer 230, a database 240, and a server controller 250.

The server communicator 210 receives the vehicle information including the learning value from the telematics terminal 100. The received information is stored and classified in the database 240. That is, as the amount of information received from a plurality of telematics terminals 100 increases, the more information is accumulated in the database 240. Further, the server communicator 210 may transmit the learning value and the vehicle diagnosis result to the repairing center server 300, the used car market server 400, and the portable terminal 500.

The authenticator 220 operates a user authentication in response to an authentication request of the telematics terminal 100. The authenticator 220 performs an authentication procedure by using user authentication information registered in advance.

The learning value analyzer 230 acquires the vehicle diagnosis result based on the information accumulated in the database 240. The vehicle diagnosis result is acquired through numerical value analysis using the learning values accumulated in the database 240. The acquired vehicle diagnosis result is stored in the database 240.

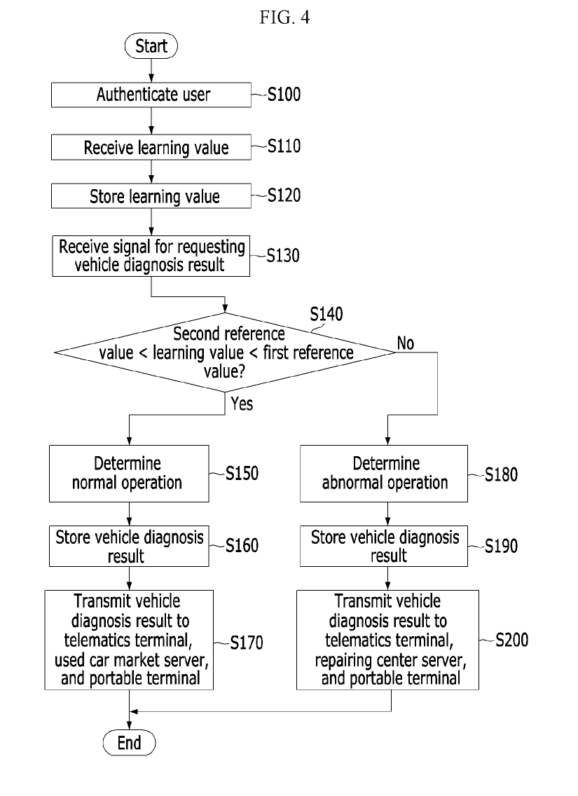

In detail, a vehicle diagnosing method using a learning value will be described below with reference to FIG. 4.

The database 240 stores the vehicle information received from the telematics terminal 100. Further, the database 240 stores the learning value and the acquired vehicle diagnosis result. That is, a change in a durability progress of a corresponding hardware may be checked based on the learning values accumulated in the database 240. Accordingly, a problem may be detected before it actually occurs in the corresponding hardware.

The server controller 250 may be implemented by one or more microprocessors that operate by a set program, and the set program may include a series of commands for performing respective steps included in a vehicle diagnosing method using a learning value according to an exemplary embodiment of the present disclosure to be described below. The server controller 250 controls an overall operation of the telematics server 200.

FIG. 4 is a flowchart illustrating a method for diagnosing a vehicle using a learning value according to another exemplary embodiment of the present disclosure.

Referring to FIG. 4, a telematics terminal 100 requests user authentication to a telematics server 200 and the telematics server 200 performs the user authentication (S100).

The telematics terminal 100 transmits a learning value to the telematics server 200, and the telematics server 200 receives the learning value (S110). In this case, the telematics terminal 100 may transmit the learning value for a set driving distance. The set driving distance may be a value determined by those skilled in the art by considering a hardware deviation with a durability progress. Then, The telematics server 200 stores the learning value in a database 240 (S120).

The user may request a vehicle diagnosis result through the telematics terminal 100. That is, the telematics server 200 receives a signal for requesting the vehicle diagnosis result from the telematics terminal 100 (S130). The telematics server 200 compares a set reference range with the learning value stored in the database 240 (S140). The set reference range may be a range determined by those skilled in the art by considering a manufacturing deviation and a durability deviation for each learning value.

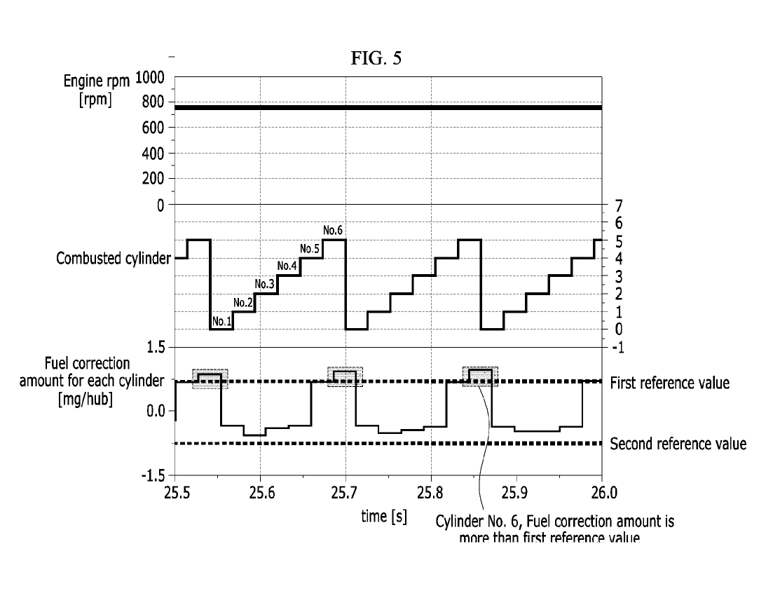

In detail, a method of comparing a learning value and a set reference range will be described below with reference to FIG. 5.

In step S140, the telematics server 200 determines an operation as a normal operation when the learning value is within the set reference range (S150). The telematics server 200 then stores a vehicle diagnosis result to determine the operation as the normal operation in the database 240 (S160).

The telematics server 200 may transmit the learning value and the vehicle diagnosis result to determine the operation as the normal operation to the telematics terminal 100, the used car market server 400, and the portable terminal 500 (S170). A used car seller or buyer may use accumulated learning values and vehicle diagnosis results when dealing with the used car, thus providing a reliable used car deal.

In step S140, the telematics server 200 determines the operation as an abnormal operation when the learning value is out of the set reference range (S180). The telematics server 200 stores the vehicle diagnosis result to determine the operation as the abnormal operation in the database 240 (S190).

The telematics server 200 may transmit the learning value and the vehicle diagnosis result to determine the operation as the abnormal operation to the telematics terminal 100, the repairing center server 300, and the portable terminal 500 (S200). The user may check the vehicle by a repairing center, such as an auto mechanic, before a problem occurs in a vehicle, and the repairing center may repair the vehicle based on the vehicle diagnosis result, thus preventing a quality problem of the vehicle in advance and decreasing vehicle repairing cost.

FIG. 5 is a graph measuring a fuel correction amount for each cylinder according to an exemplary embodiment of the present disclosure.

Referring to FIG. 5, an electronic control unit (ECU) may control a fuel balancing to correct a fuel amount by detecting an RPM deviation for each cylinder.

A hardware deviation, abrasion of a cylinder in the durability progress, and a difference in torque for each cylinder due to head sealing may cause the RPM deviation for each cylinder. Engine disorder and vibration may occur due to the RPM deviation for each cylinder, and in particular, a driver may feel displeasure in an idle state in which an RPM is low. The ECU operates a learning control to maintain a speed and pressure by controlling the fuel amount for each cylinder.

The fuel correction amount for each cylinder is the learning value, and the reference range is set based on a first reference value and a second reference value. The first reference value may be set to a maximum value of the fuel correction amount which may be permitted when an injector and the cylinder are normal. The second reference value may be set to a minimum value of the fuel correction amount which may be permitted when the injector and the cylinder are normal.

The driver may indirectly determine that the injector and the cylinder are abnormal based on a result in which a fuel correction amount of cylinder No. 6 is more than the first reference value. Accordingly, the driver may minimize an influence on other hardware through checking at the vehicle repairing center in advance.

As a result, according to an exemplary embodiment of the present disclosure, it may be determined in advance whether a control system mounted on the vehicle operates normally by using the telematics terminal 100 and the learning value.

The quality problem of the vehicle is prevented in advance, and the vehicle repairing cost is decreased by checking at the repairing center before the problem occurs in the vehicle. The reliable dealing may be achieved based on the accumulated learning values and vehicle diagnosis results when dealing with the used car. A component deviation management level based on data may be increased by using the accumulated learning values.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A method for diagnosing a vehicle by using a learning value used in a learning control of a control system mounted on a vehicle by a telematics server, the method comprising:
performing user authentication in response to an authentication request of a telematics terminal;
receiving the learning value from the telematics terminal;
storing the received learning value in a database;
comparing a set reference range with the learning value stored in the database;
determining whether the control system operates normally according to a comparison result; and
storing a vehicle diagnosis result in the database.

2. The method of claim 1, wherein in the step of determining whether the control system operates normally, it is determined that the control system operates normally when the learning value is within the set reference range and determined that the control system operates abnormally is used when the learning value is out of the set reference range.

3. The method of claim 1, wherein in the step of receiving the learning value, the learning value is received from the telematics terminal for each set driving distance.

4. The method of claim 1, further comprising:
receiving a signal for requesting the vehicle diagnosis result from the telematics terminal; and
transmitting the vehicle diagnosis result to the telematics terminal.

5. The method of claim 1, further comprising transmitting the vehicle diagnosis result to a used car market server.

6. The method of claim 1, further comprising:
transmitting the vehicle diagnosis result to the telematics terminal or a portable terminal when the learning value is out of the set reference range; and
transmitting the vehicle diagnosis result to a repairing center server.

7. The method of claim 1, wherein the learning value is a fuel correction amount for each cylinder.

8. A system for diagnosing a vehicle by using a learning value used in a learning control of a control system mounted on a vehicle, the system comprising:
a telematics terminal collecting the learning value from the control system and transmitting the collected learning value to the outside; and
a telematics server receiving the learning value from the telematics terminal, comparing a set reference range with the learning value to determine whether the control system using the learning value operates normally according to a comparison result, and transmitting a vehicle diagnosis result to the outside.

9. The system of claim 8, wherein the telematics terminal transmits the learning value to the telematics server for each set driving distance.

10. The system of claim 8, further comprising at least one of a used car market server, a portable terminal, and a repairing center server that receive the vehicle diagnosis result.

11. The system of claim 8, wherein the telematics terminal includes:
an information collector collecting the learning value from the control system;
a terminal communicator transmitting the collected learning value to the telematics server through a wireless communication network and receiving the vehicle diagnosis result from the telematics server;
a display displaying the vehicle diagnosis result; and
a terminal controller transmitting the collected learning value, and controlling the learning value collector, the terminal communicator, and the display to display the vehicle diagnosis result.

12. The system of claim 8, wherein the telematics server includes:
a server communicator receiving the learning value from the telematics terminal and transmitting the vehicle diagnosis result to the telematics terminal;
a database storing the learning value and the vehicle diagnosis result;
a learning value analyzer comparing a set reference range with the learning value stored in the database to determine whether the control system operates normally based on a comparison result; and
a server controller controlling the server communicator, the database, and the learning value analyzer to transmit the vehicle diagnosis result to the telematics terminal.
